(19) United States
(12) Patent Application Publication
(10) Pub. No.: US 2010/0059044 A1
(43) Pub. Date: Mar. 11, 2010

(54) PRESSURIZED OPEN LOOP FREEZE PROTECTED INTEGRAL STORAGE COLLECTOR SOLAR WATER-HEATING SYSTEM

(76) Inventor: Ofer DAGAN, Amakim (IL)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/621,198

(22) Filed: Nov. 18, 2009

Related U.S. Application Data
(63) Continuation of application No. 10/579,384, filed on Dec. 13, 2007, now abandoned.

(30) Foreign Application Priority Data
Nov. 20, 2003 (IL) 158968

(51) Int. Cl. F24J 2/40; F24J 2/04; F24J 2/42; B23P 15/26

(52) U.S. Cl. 126/585; 126/640; 126/615; 126/646; 29/890.033

(57) ABSTRACT

An integral storage-collector solar water-heating system is disclosed. The system includes a tank and two absorbers, wherein the entire system is full of water. The water circulation goes from the bottom of the tank trough a fine-tube absorber plate, which is located between a transparent cover exposed to the sun and an insulated plate. The heated water passes through a second absorber that heats them to a usage temperature and cause them flows into the tank's space. The second absorber is created between the exposed wall of the tank, by a grid of tunnels that are grooved in a thermally insulated layer that are attached to the inside walls of the tank. The second absorber is covered with transparent cover too. The water flow into the upper part of the tank and a thermo-siphon valve prevents the back flow. After a double heating, the water is stored inside the tank and ready for use.

The system can also have an electrical heating option, a flexible turbolator in the fin-tube absorber to be shrunk in case of freezing and flexible means inside the tank for the same purpose.

### CROSS-REFERENCE TO RELATED APPLICATION

The present application is a Continuation Application of U.S. application Ser. No. 10/579,384 filed May 11, 2006 which is incorporated herein by reference, which is a U.S. National Phase Application under 35 USC 371 of International Application PCT/IL2004/001061 filed Nov. 18, 2004, which claims priority from Israeli Application No. 158968, filed Nov. 20, 2003.

### FIELD OF THE INVENTION

The present invention relates to a solar energy system. More specifically, the present invention relates to a system for heating water by solar energy.

### BACKGROUND OF THE INVENTION

Solar water heaters are well known and in used for many years. They are divided to few groups. One of these groups is the integral solar water heater. These systems characterized by the fact that the face of the storage tank or part of it is used as solar absorber.

The advantages of Integral SWH Systems compare with standard SWH Systems. They are cheaper, easy to install, reduce installation area, esthetic and attractive shape.

The disadvantages of Integral SWH Systems are that they have a very high heat loss, a very high mixing of hot and cold water in the storage tank, and usable hot water only at the end of the day.

The present invention developed to reduce the problems and disadvantages of the common SWH systems by using the integral storage collector configuration with a solution to the problems that pointed out earlier. The present invention is a system that includes all the parts that need to work properly. Easy-to-install with tree feeding lines (cold water inlet, hot water outlet and feeding electric wire cable), higher reliability, efficiency, ecstatic, and better performance. To achieve these goals, many technology improvements were introduced into the system.

The system, according to the present invention, is friendly, lightweight, flexible, simple and easy to install.

This simplicity enables to:
Simplified system installation.
Shortened system installation time.
Decrees transportation difficulties.
Reduce Installation cost.
Reduce trouble-shooting problems.
Compact construction with fewer parts and less production and assembly hours—the present invention builds of fewer parts and need less assembly hours than a standard SWH system, which cause a reduction of the time that is needed to produce the present invention.
Simplified production processes enable reduce system costs.

The present invention has high level of esthetics. The system shape enables to integrate it in a simple way into an inclined roof or putting it on a flat roof.

The advantages of the invention compare to other integral solar systems are:
Low heat loss (can be control by the developer).
Short solar heating time to get a water temperature ready for use.
Open loop, thermo-siphon system.
Protected from Freezing.
Electric heating element that operate as heat accelerator and heat any amount of water to the usage temperature.
When the temperature of the water is less than need for usage, the electric heating element operates as a flow heater and raises the water temperature that leaves the storage tank.

The advantages of the invention compare to standard solar system are:
The amount of row material and the number of parts that used in the new Integral SWH System is less.
The number of production process used in the new Integral SWH System is less.
The transportation volume is smaller (it is possible to transport more units in the same car).
The present invention is a lightweight system and equipped with special units that enables to carry it in an easy and simple way.
The present invention equipped with all the fittings that are assembly in it as an integral part.
The installation of the system of the present invention, in a location, is faster and simpler than a standard system. All the installer should do is:
   To connect the cold water inlet.
   To connect the hot water outlet.
   To connect the Electric feeding wire.
The system, according to the present invention, enables to use the roof more efficiently and to install more new systems on the same roof area size (incline roof or flat roof).

The U.S. Pat. No. 5,462,047 to Kleinwachter et al discloses an integral solar heating system, which is an un pressurized system and includes a single absorber. Moreover, this system has no protection against freezing. The U.S. Pat. No. 6,009,906 to Salazar discloses a method for protecting pipes in case of freezing by using a compressible flexible core that shrinks while freezing take place. In the present invention a shrinkable turbolator is used for this purpose.

A turbolator is a helical shape core, usually made of metal, located inside heat exchanger pipes for increasing heat transfer efficiency.

In the present invention a “thermo-siphon valve” is used. The thermo-siphon valve is a well known one-way valve that allows flowing hot water up and prevents the back flow of water down.

### SUMMARY OF THE INVENTION

The present invention is a pressurized open-loop freeze protected integral storage collector solar water-heating system.

According to the teaching of the present invention it is provided a pressurized open-loop freeze protected integral storage collector solar water-heating system that includes:
a tank having an inlet for city water inlet—located in the lower side of the tank, a first outlet for supplying water—located in the upper side of the tank—and a second outlet for feeding water to a fin—tube absorber—located in the lower side of the tank:
a thermally insulated layer, which is attached to the inside walls of the tank; and
an upper solar tank-absorber and a lower solar fin-tube absorber, each for the purpose of enabling a flow of water there-through to which solar heat collected by the absorbers can be transferred, wherein:
   the upper solar tank-absorber is built inside the exposed wall of the tank, having an inlet and an outlet into the tank; and
   the lower solar fin-tube absorber has an inlet and an outlet, wherein the inlet is connected to the second outlet of the tank and the outlet is connected to the inlet of the upper solar tank-absorber.

According to a preferred embodiment of the present invention the integral storage-collector solar water heating system is provided, wherein the water flow means of the upper solar tank-absorber are created between the thermally insulated layer and the exposed walls of the tank, by a grid of tunnels that are grooved in the thermally insulated layer.

According to another preferred embodiment of the present invention the integral storage-collector solar water heating system is provided, wherein the system is a low-profile solar system, which the bottom of the tank is located higher than the middle of the solar absorbers

According to another preferred embodiment of the present invention the integral storage-collector solar water heating system is provided, wherein the thermally insulated layer is built of two parts, an upper part and a lower part, wherein the two parts are parted by a flexible material for the purpose of shrinking, while the water inside the solar-tank absorber is freezing.

According to another preferred embodiment of the present invention the integral storage-collector solar water heating system is provided, wherein the system further includes at least one of flexible means, located between the thermally insulated layer and the opposite wall of the exposed wall of the tank, for the purpose of shrinking while the water inside the solar tank absorber is freezing.

According to another preferred embodiment of the present invention there is provided an integral storage-collector solar water heating system, further includes:
a water-supplying pipe, connected to the outlet of the tank enabling to supply water from the tank;
an electrical heating element, the element is attached around the supplying pipe for heating—when the element is activated—the water that is flowing there-through; and
a thermo-siphon valve that is connected between the end of the supplying-pipe, and second outlet located at the lower part of the tank or to the city water inlet in order to prevent the flow of the city water—directly or via the tank—through the water outlet while supplying water, wherein the thermo-siphon enables the circle of water from the lower side to the upper side of the tank through the supplying-pipe while the water is being heated by the electrical element.

According to another preferred embodiment of the present invention there is provided an integral storage-collector solar water heating system, wherein the tank further includes a plurality of horizontal dividing-plates, dividing the tank into a plurality of cells, in order to increase stratification in the tank, wherein each of the dividing-plate have a small opening enabling water to pass through and wherein the opening is located opposite to the openings of the neighbors' dividing-plates.

According to another preferred embodiment of the present invention there is provided an integral storage-collector solar water heating system, wherein the lower solar fin-tube absorber further includes a turbolator longitudinally inside the water flow means in order to increase heat transfer efficiency and wherein the turbolator is made of flexible material that is capable to be shrink while the water inside the water flow means is freezing.

According to another preferred embodiment of the present invention there is provided an integral storage-collector solar water heating system, further includes a water-supplying pipe, connected to the outlet of the tank enabling the tank to supply water and wherein the end of the water-supplying pipe and the inlet of the tank are on the same level, enabling to connect plurality of the system serially.

According to another preferred embodiment of the present invention there is provided an integral storage-collector solar water heating system, further includes at least one prop, pivotally joined to the system enabling to install the system in a variety of angles.

According to yet another preferred embodiment of the present invention there is provided an integral storage-collector solar water heating system, further includes a protractor and a compass, enabling to install the system in a variety of position according to given instructions.

According to another aspect of the present invention there is provided an integral storage-collector solar water heating system including:
a tank having an inlet for city water inlet—located in the lower side of the tank—and an outlet for supplying water—located in the upper side of the tank, second outlet for feeding a fin—tube absorber—located in the lower side of the tank;
a thermally insulated layer, which is attached to the inside walls of the tank, wherein the thermally insulated layer is built of two parts, an upper part and a lower part, wherein the two parts are parted by a flexible material;
a solar tank-absorber and a solar fin-tube absorber, each for the purpose of enabling a flow of water there-through to which solar heat collected by the absorbers can be transferred, wherein:
   the solar tank-absorber is created between the thermally insulated layer and the exposed walls of the tank, by a grid of tunnels that are grooved in the thermally insulated layer, having an inlet and an outlet into the tank; and
   the solar fin-tube absorber has an inlet and an outlet, wherein the inlet is connected to the second outlet of the tank or to the city water inlet pipe and the outlet is connected to the inlet of the upper solar tank-absorber;
a plurality of horizontal dividing-plates, dividing the tank into a plurality of cells, wherein each of the dividing-plate has a small opening enabling water to pass through and wherein the opening is located opposite to the openings of the neighbors' dividing-plates;
at least one of flexible means, located between the lower part of the thermally insulated layer and the bottom of the tank, for the purpose of shrinking while the water inside the tunnels of the solar tank absorber is freezing;
a water-supplying pipe, connected to the outlet of the tank enabling to supply water from the tank;
an electrical heating element, the element is attached around the supplying pipe for heating—when the element is activated—the water that is flowing there-through;
a thermo-siphon valve that is connected between the end of the supplying-pipe, parallel to the water outlet of the supplying-pipe and to the lower part of the tank or to the city water, in order to prevent the flow of the city water—directly or via the tank—through the water outlet while supplying water, wherein the thermo-siphon enables the circle of water from the lower side to the upper side of the tank through the supplying-pipe while the water is being heated by the electrical element; and
a turbolator located longitudinally inside the water flow means of the solar fin-tube absorber, wherein the turbolator is made of a flexible material that is capable to be shrink while the water inside the water flow means is freezing.

According to another preferred embodiment of the present invention there is provided an integral storage-collector solar water heating system, further includes a circulating pump in order to circle water from the tank through the absorbers.

According to another preferred embodiment of the present invention there is provided an integral storage-collector solar water heating system, wherein the circulating pump has a sensor that activates the circulating pump according to predetermined temperature and/or radiation level.

According to another preferred embodiment of the present invention there is provided an integral storage-collector solar water heating system, wherein the fin-tube absorber is located higher than the tank and the fin-tube absorber is empty when the circulation pump is not activated.

According to another aspect of the present invention there is provided a method of storage-collector solar water-heating, includes the following steps:
installing a water-flow-grid in a tank, by grooving grids of tunnels in a thermally insulated layer and attaching the grooved side of the thermally insulated layer to the exposed wall inside of the tank, wherein the water-flow-grid has an inlet and an outlet;
installing a thermo-siphon valve or a circulation pump between the inside space of the tank and outlet of the water-flow-grid; and
connecting an external absorber between the bottom of the tank and the inlet of the water-flow-grid.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the figures:

FIG. 1 illustrates a basic drawing of the present invention.

FIG. 2 illustrates a cross section of the tank with antifreeze protection elements.

FIG. 3 illustrates the location of the dividing-plates inside the tank of the present invention.

FIG. 4 illustrates a cross section of a preferred embodiment of the system, according to the present invention.

FIG. 5 illustrates a serial connection of a plurality of the present invention system.

### DESCRIPTION OF THE PREFERRED EMBODIMENTS

The present invention is an integral storage-collector solar water-heating system. The system includes a tank and two absorbers, wherein the entire system is full of water. The water circulation goes from the bottom of the tank trough a fine-tube absorber plate, which is located between a transparent cover exposed to the sun and an insulated plate. The heated water passes through a second absorber that heats them to a usage temperature and cause them flows into the tank's space. The second absorber is created between the exposed wall of the tank, by a grid of tunnels that are grooved in a thermally insulated layer that are attached to the inside walls of the tank. The second absorber is covered with transparent cover too. The water flow into the upper part of the tank and a thermo-siphon valve prevents the back flow. After a double heating, the water is stored inside the tank and ready for use.

The system can also have an electrical heating option, a flexible turbolator in the fin-tube absorber to be shrunk in case of freezing and flexible means inside the tank for the same purpose.

The principles and operation of the integral storage-collector solar water-heating system according to the present invention may be better understood with reference to the drawing and the accompanying description.

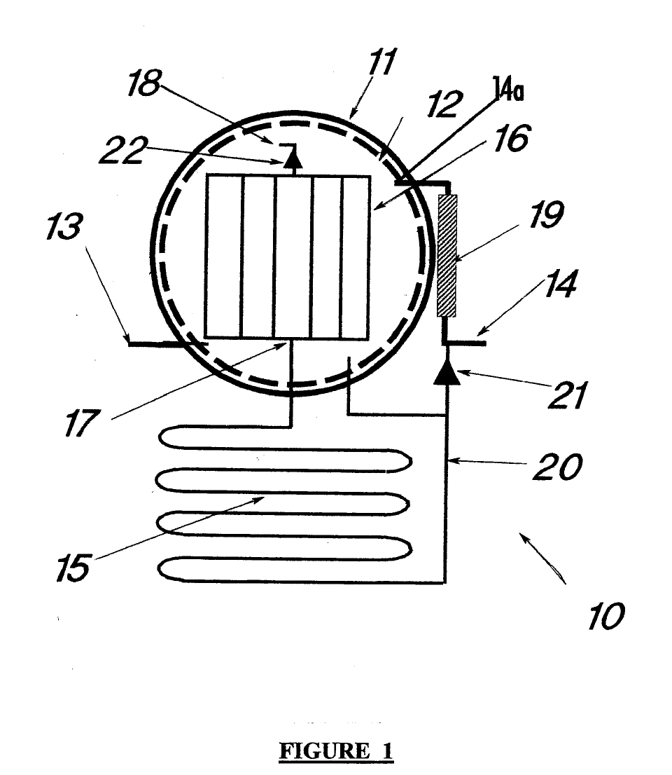

Referring now to the drawing, FIG. 1 illustrates a basic drawing of the present invention. The system 10 is made of a water tank 11 with a thermally insulated layer 12 attached to the inside walls of the tank 11. The tank 11 has an inlet 13 for connecting to the city water and an outlet 14 for supplying hot water. The system has two absorbers, a fin-tube absorber 15 and a tank absorber 16, which have grooved tunnels in the thermally insulated layer 12 that are located in the exposed wall of the tank 11. The city water enters to the tank 11 through the inlet 13 and flows via a pipe 20 to the bottom of the fine-tube absorber 15. Solar energy heats the water. The temperature difference between the water in the absorber inlet pipe 20 and the water inside the absorber 15, creates a pressure that forces the water to move up—via the absorbers connection 17—to the tank-absorber 16 wherein the water temperature is raised and the water flows through a thermo-siphon valve 22 and via the tank-absorber's outlet 18 into the tank 11. For electrical heating option, an electrical heating element 19 is attached around the outlet pipe 14. When the electrical element 19 is activated, and the water temperature is less then a thermostat set point, the supplied water is heated by the electrical element 19 and while water is not used the thermo-siphon valve 21 allows cold water to flow from the bottom of the tank 11, via the pipe 20 and the outlet pipe 14, into the tank 11 while the water is heated by the electrical element 19.

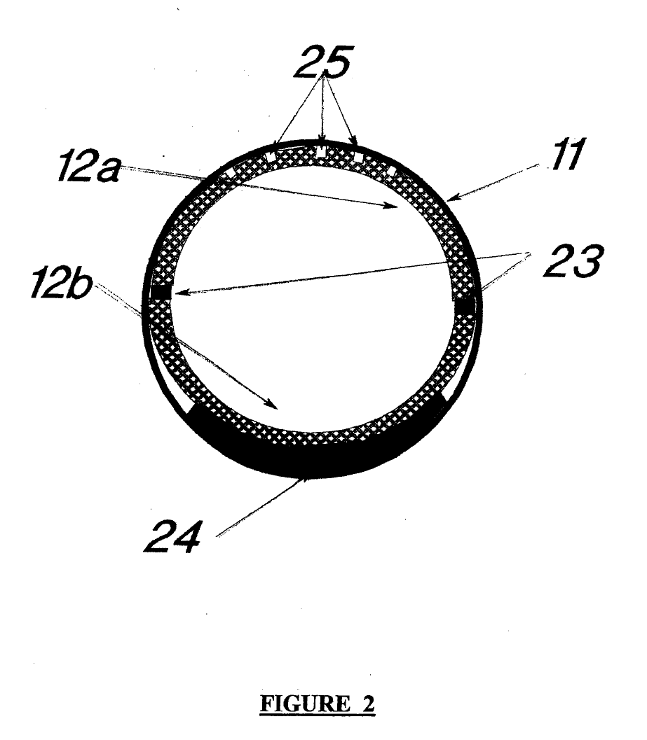

FIG. 2 illustrates a cross section of the tank with antifreeze protection elements. Two parts of thermal insulated layers are attached to the inside walls of the tank 11, the first part 12a and the second part 12b, both are connected by flexible connector 23. Another flexible material 24 is installed between the second layer part 12b and the unexposed tank wall 11. In case that the water in the grooved tunnels 25 or in the tank are freezing, the first layer part 12a, and or second layer part 12b, is pushed down and the flexible connector 23 and or flexible material 24 are shrunk, which enables to evacuate space for the freezing water.

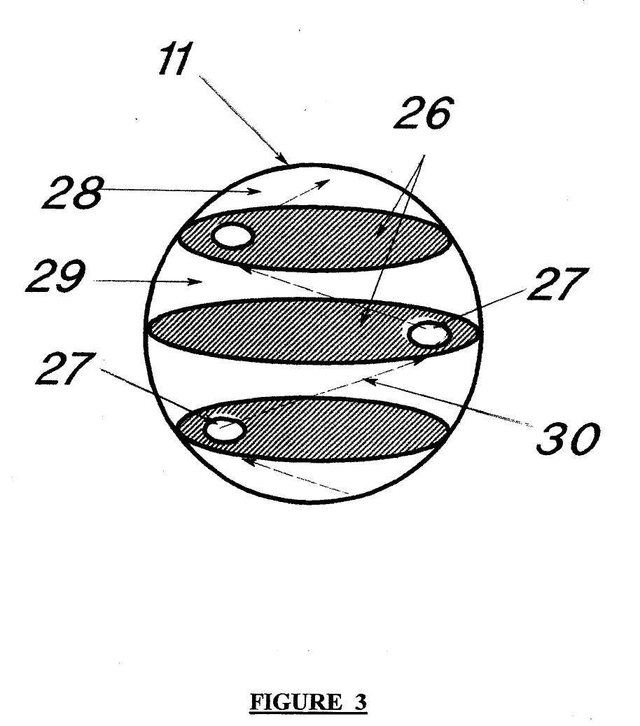

FIG. 3 illustrates the location of the dividing-plates inside the tank of the present invention. A plurality of dividing plates 26 are separating the tank 11 to a plurality of horizontal cells in order to increase stratification in the tank 11. Each plate has an opening 27 wherein each dividing-plate opening is located opposite to the openings of the neighbors' dividing-plates in order to make the flow pattern 30 longer. Increasing the flow pattern length, cause a reduction of contact area between hot and cold layers. This reduction reduces heat transfer between the layers and increase solar fraction. Therefore the difference temperature between plates 26 is significant. Cells 28 & 29 are created with different temperature; the higher cell has the higher temperature. Since the hot water enters to the highest cell 28, the temperature in this cell is higher than in the lower cell 29 and so on. The used water is supplied from the highest cell 28 and therefore the user has water with a high temperature.

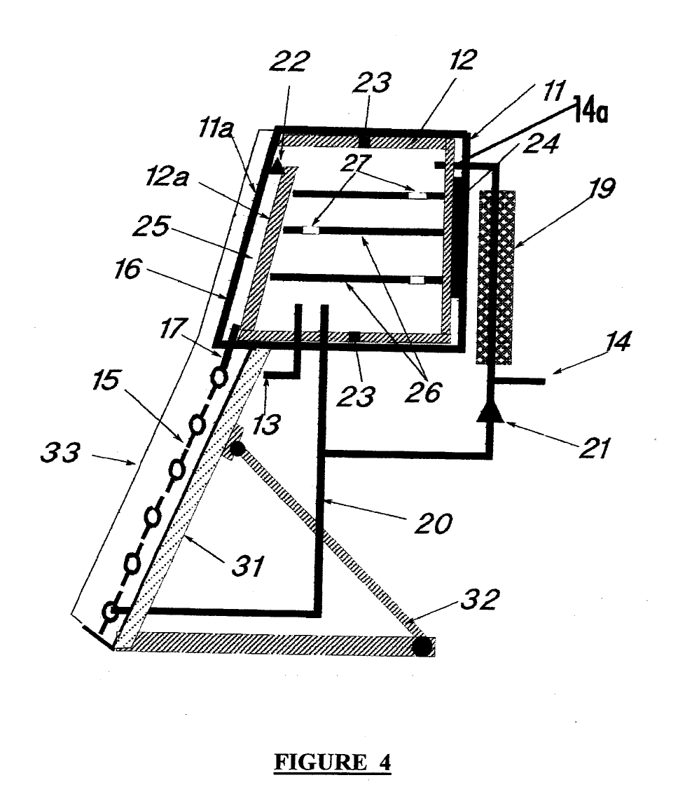

FIG. 4 illustrates a cross section of a preferred embodiment of the system, according to the present invention. Basically, the system comprised of a tank 11 and two absorbers—the tank-absorber 16 and the fin-tube absorber 15.

The bottom of the tank 11 is a little bit higher then half of the total height of the two absorbers 15&16 and lowers then the height of the two absorbers 15&16. Reducing the tank's 11 height below the absorbers height, cause the thermosiphon force to decrease and by that cause a reduction of flow rate that increase the water temperature. Along the day the tank 11 is filled with hot water. Lowering the contact layer of hot and cold, reduce the thermosiphon forces, decrease the flow and increase the water temperature. By keeping the height of the bottom of the storage tank according to the new invention, the water temperature leaving the absorbers is high enough for usage. The difference temperature between cells is significant. Cells are created, between the dividing plates 27, with different temperature; the higher cell has the higher temperature. Since the hot water enters to the highest cell, the temperature in this cell is higher than in the lower cell and so on. The used water is supplied from the highest cell and therefore the user has water with usage temperature.

A transparent plate 33 covers both absorbers 15 & 16 and the fin-tube absorber 15 has an insulated back by a thermal insulated plate 31. The system is assembled by additional elements, which will describe as the following.

The tank-absorber 16 is created by the exposed wall 11a of the tank 11 and the layer-part 12a of the thermal insulated layer 12 that is attached to the exposed wall 11a, by, tunnels 25 that are grooved in the layer-part 12a.

The city water enters the tank 11 through the tank inlet 13 and via a pipe 20, which flows to the bottom of the fin-tube absorber 15 wherein the solar energy is collected and is transferred to the water. The hot water flows up through a connector 17 to the tunnels 25 of the tank-absorber 16, the water temperature is raised and the water flows through a thermo-siphon valve 22 into the tank 11. In order to keep the water temperature, a thermal-insulated layer 12 is attached to the inside walls of the tank 11. A plurality of dividing plates 26 are installed inside the tank 11 dividing it into a cells, wherein each dividing plate 26 has an opening 27, which is located opposite to the openings of the neighbors' dividing-plates. This structure is made in order to increase stratification in the tank.

To protect the system in case of freezing, the thermal insulated layer 12 is divided and connected by a flexible connector 23 and a flexible material 24 is installed between the tank's wall and the layer 12. In case that the water in the grooved tunnels 25 or in the tank 11 freeze, the first layer part 12a, and/or second layer part 12b, is pushed down and the flexible connector 23 and/or flexible material 24 are shrunk, which enables to evacuate space for the freezing water.

To avoid freezing damages in the fin-tube absorber 15, it is possible to install it higher than the tank-absorber 16. In this case, a circulation pump is installed instead of the thermo-siphon valve 22 and the pump is activated in dependence to the radiation and/or temperature. In a low radiation, the temperature falls down; the pump stops and the fin-tube absorber 15 drain from water. This mode is called auto-drain.

For electrical heating option, an electrical heating element 19 is attached around the water-supplying pipe 14, which heats the flow water there through, while activated and thermostat set point is higher then water temperature.

In the period of time when water is not supplied, the water inside the supplying pipe 14 is heated by the electrical element 19 and flows to the tank 11 while sucking cold water from the tank's bottom via a pipe 20 through a thermo-siphon valve 21, which prevents hot water back flow.

The system includes at least one prop 32 enabling to install the system in a variety of angles.

To achieve maximal solar thermal efficiency, it is recommended that the height of the tank's bottom from the system bottom should be a little bit more than half of the total height of the system.

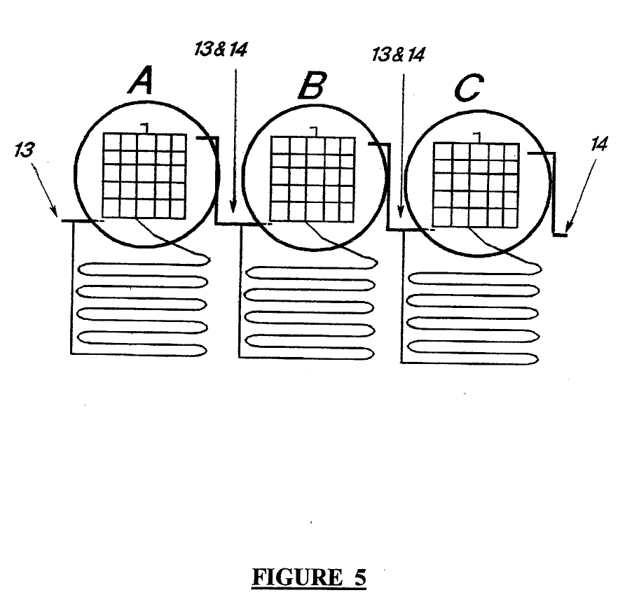

FIG. 5 illustrates a serial connection of a plurality of the present invention system. In a preferred embodiment the inlet 13 and the outlet 14 of the system are in the same level, enabling to connect the outlet 14 of system A to the inlet 13 of system B and the same system B to system C, having three systems connected serially.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

What is claimed is:

1. An integral storage-collector solar water-heating system comprising:
a tank having an inlet for city water inlet—located in the lower side of said tank, a first outlet for supplying water—located in the upper side of said tank—and a second outlet for feeding water to a fin—tube absorber—located in the lower side of said tank:
a thermally insulated layer, which is attached to the inside walls of said tank; and
an upper solar tank-absorber and a lower solar fin-tube absorber, each for the purpose of enabling a flow of water there-through to which solar heat collected by the absorbers can be transferred, wherein:
said upper solar tank-absorber is built inside the exposed wall of said tank, by a grid of tunnels that are grooved in said thermally insulated layer, having an inlet and an outlet into said tank; and
said lower solar fin-tube absorber has an inlet and an outlet, wherein said inlet is connected to said second outlet of said tank and said outlet is connected to said inlet of said upper solar tank-absorber.

2. The system of claim 1, wherein the water flow means of said upper solar tank-absorber are created between said thermally insulated layer and the exposed walls of said tank, by a grid of tunnels that are grooved in said thermally insulated layer.

3. The system of claim 1, wherein said system is a low-profile solar system, which the bottom of said tank is located higher than the middle of said solar absorbers.

4. The system of claim 1, wherein said thermally insulated layer is built of two parts, an upper part and a lower part, wherein said two parts are parted by flexible material for the purpose of shrinking while the water inside said solar-tank absorber is freezing.

5. The system of claim 1, wherein said system further includes at least one of flexible means, located between said thermally insulated layer and the opposite wall of said exposed wall of said tank, for the purpose of shrinking while the water inside said solar tank absorber is freezing.

6. The system of claim 1, further includes:
a water-supplying pipe, connected to said outlet of said tank enabling to supply water from said tank;
an electrical heating element, said element is attached around said supplying pipe for heating—when said element is activated—the water that is flowing there-through;
a thermo-siphon valve that is connected between the end of said supplying-pipe, and second outlet locate at the lower part of said tank or to the city water inlet in order to prevent the flow of the city water—directly or via said tank—through said water outlet while supplying water, wherein said thermo-siphon enables the circle of water from the lower side to the upper side of said tank through said supplying-pipe while said water is being heated by said electrical element.

7. The system of claim 1, wherein said tank further includes a plurality of horizontal dividing-plates, dividing said tank into a plurality of cells, in order to increase stratification in tank, wherein each of said dividing-plate has a small opening enabling water to pass through and wherein said opening is located opposite to the openings of the neighbors' dividing-plates.

8. The system of claim 1, wherein said lower solar fin-tube absorber further includes a turbolator longitudinally inside the water flow means in order to increase heat transfer efficiency and wherein said turbolator is made of flexible material that is capable to be shrunk while the water inside said water flow means is freezing.

9. The system of claim 1, further includes a water-supplying pipe, connected to the outlet of said tank enabling said tank to supply water and wherein the end of said water-supplying pipe and the inlet of said tank are on the same level, enabling to connect plurality of said system serially.

10. The system of claim 1, further includes at least one prop, pivotally joined to said system enabling to install said system in a variety of angles.

11. The system of claim 10, further includes a protractor and a compass, enabling to install said system in a variety of position according to given instructions.

12. An integral storage-collector solar water-heating system comprising: a tank having an inlet for city water inlet—located in the lower side of said tank—and an outlet for supplying water—located in the upper side of said tank, second outlet for feeding a fin—tube absorber—located in the lower side of said tank;
a thermally insulated layer, which is attached to the inside walls of said tank, wherein said thermally insulated layer is built of two parts, an upper part and a lower part, wherein said two parts are parted by flexible material;
a solar tank-absorber and a solar fin-tube absorber, each for the purpose of enabling a flow of water there-through to which solar heat collected by the absorbers can be transferred, wherein:
said solar tank-absorber is created between said thermally insulated layer and the exposed walls of said tank, by a grid of tunnels that are grooved in said thermally insulated layer, having an inlet and an outlet into said tank; and
said solar fin-tube absorber has an inlet and an outlet, wherein said inlet is connected to said second outlet of said tank or to the city water inlet pipe and said outlet is connected to said inlet of said upper solar tank-absorber;
a plurality of horizontal dividing-plates, dividing said tank into a plurality of cells, wherein each of said dividing-plate has a small opening enabling water to pass through and wherein said opening is located opposite to the openings of the neighbors' dividing-plates;
at least one of flexible means, located between said lower part of said thermally insulated layer and the bottom of said tank, for the purpose of shrinking while the water inside said solar tank absorber is freezing;
a water-supplying pipe, connected to said outlet of said tank enabling to supply water from said tank;
an electrical heating element, said element is attached around said supplying pipe for heating—when said element is activated—the water that is flowing there-through;
a thermo-siphon valve that is connected between the end of said supplying-pipe, parallel to the water outlet of said supplying-pipe and to the lower part of said tank or to the city water, in order to prevent the flow of the city water—directly or via said tank—through said water outlet while supplying water, wherein said thermo-siphon enables the circle of water from the lower side to the upper side of said tank through said supplying-pipe while said water is being heated by said electrical element; and
a turbolator located longitudinally inside the water flow means of said solar fin-tube absorber, wherein said turbolator is made of flexible material that capable to be shrunk while the water inside said water flow means is freezing.

13. The system of claim 12, further includes a circulating pump in order to circle water from said tank through said absorbers.

14. The system of claim 13, wherein said circulating pump has a sensor that activates said circulating pump according to predetermined temperature and/or radiation level.

15. The system of claim 14, wherein said fin-tube absorber is located higher than said tank and said fin-tube absorber is empty when said circulation pump is not activated.

16. A method of storage-collector solar water-heating comprising:
creating a grid of tunnels in a tank, by grooving grid of tunnels in a thermally insulated layer and attaching the grooved side of said thermally insulated layer to an exposed wall inside of said tank, wherein said water-flow-grid has an inlet and an outlet;
installing a thermo-siphon valve or a circulation pump between said inside space of said tank and outlet of said grid of tunnels; and
connecting an external absorber between the bottom of said tank and the inlet of said grid of tunnels.
